(19) United States
(12) Patent Application Publication
(10) Pub. No.: US 2010/0030755 A1
(43) Pub. Date: Feb. 4, 2010

(54) METHOD FOR INFERRING PERSONAL RELATIONSHIP BY USING READABLE DATA, AND METHOD AND SYSTEM FOR ATTACHING TAG TO DIGITAL DATA BY USING THE READABLE DATA

(75) Inventor: Junhwan Kim, Seoul (KR)

Correspondence Address: HUSCH BLACKWELL SANDERS LLP, 190 Carondelet Plaza, Suite 600, ST. LOUIS, MO, 63105, US

(73) Assignee: OLAWORKS INC., Seoul (KR)

(21) Appl. No.: 12/577,181

(22) Filed: Oct. 10, 2009

Related U.S. Application Data
(63) Continuation of application No. PCT/KR2008/002032, filed on Apr. 10, 2008.

(30) Foreign Application Priority Data
Apr. 10, 2007 (KR) 10-2007-0035279

(51) Int. Cl. G06F 17/30; G06F 15/16

(52) U.S. Cl. 707/3; 707/104.1; 709/206; 707/E17.014; 707/E17.005

(57) ABSTRACT

There are provided a method for inferring a personal relationship of a user from readable data, and a method and a system for more precisely recognizing a certain person included in digital data created by a digital device of the user by using the readable data. More particularly, a method for analyzing readable data and inferring a personal relationship of the user from the analyzed readable data is provided. Further, a method and a system for providing a plurality of candidates having high probabilities of being determined as the certain person by referring to the readable data, and attaching tag information to the digital data by using information on the plurality of the candidates are provided. Using such methods and a system, the personal relationship of the user can be automatically inferred, thus tagging the digital data with ease.

### CROSS-REFERENCE TO RELATED APPLICATION

This application is a continuation of prior International Application PCT Application No. PCT/KR2008/002032 filed on Apr. 10, 2008, which claims the benefit of priority from Korean Patent Application No. 10-2007-0035279 filed on Apr. 10, 2007. The disclosures of International Application PCT Application No. PCT/KR2008/002032 and Korean Patent Application No. 10-2007-0035279 are incorporated herein by reference.

### FIELD OF THE INVENTION

The present invention relates to a method for inferring a personal relationship or a schedule of a user (of a digital device) from readable data, and a method and a system for attaching tag information to a digital data by using the readable data. More particularly, the present invention relates to a method for extracting the information on the personal relationship or the schedule of the user from the readable data, and a method and a system for automatically attaching tag information associated with a person included in the digital data by using the readable data.

### BACKGROUND OF THE INVENTION

In recent years, a digital device such as a digital camera, a mobile communication device equipped with a camera, a digital camcorder, and an MP3 player has been widespread to increase the opportunity for a user to create and exchange digital data. The more digital data are created and exchanged, the more systematically the digital data are required to be managed.

In general, however, it is difficult to manage, retrieve and extract the digital data by classifying or integrating the digital data, because the digital data are certain to include enormous amount of information therein.

A scheme for classifying or integrating the digital data by using a tag is widely known as one of the conventional techniques for managing digital data. A “tag” can be understood as additional data attached to a digital data for the purpose of accessing or searching for the digital data as quickly as possible. Such a tag is generally comprised of a series of characters, numbers, or a combination of numbers and characters.

There are various types of tags as follows: a space tag, a person tag, an object tag, a time tag and the like. Especially, a lot of attempts have been made to extract the person tags from the digital data with a high accuracy.

FIG. 1 describes a face recognition scheme by using a face appearance feature and a contextual feature. In this regard, Microsoft Research Asia has published an article entitled “Automated Annotation of Human Faces in Family Albums” in 2003. This article discloses a technique of adding the contextual feature to the conventional face recognition algorithm in order to improve a recognition rate of people included in images of photos. The contextual feature represents that people included in images of a plurality of photos taken on the same day or in the same event may wear the same clothes. Such contextual feature can be used to distinguish each of the people in the photos.

According to the above-mentioned article, the face recognition algorithm based on the contextual feature cannot be applied to two or more sheets of photos taken on distant dates, e.g., at intervals of three or more days. Thus, the article says that the photos are required to be taken within at most two days to apply such similarity, i.e., the contextual feature.

However, the conventional face recognition technique disclosed in the above article lacks in accuracy in that the face recognition is performed by analyzing only the similarity of clothes of people within a specific range of time and in addition to the similarity of the face appearance feature. For example, there may often be a case where the same person wears different clothes even when the specific range of time is set to one or two days. Specifically, during spring, autumn, or winter, we can imagine that one who wears a jumper over a shirt in an outdoor area may wear the shirt merely in an indoor area. Moreover, when a person whose face and body tilted to one side is taken a photograph of, there may be a severe problem in that the accuracy of the recognition rate of the clothes and the face of the person is degraded.

In the meantime, it is well known that information on the user may be extracted from character data by checking a call history, an SMS (Short Message Service) history, an Email history, and the like. However, a personal relationship between the user and the user's acquaintances may not be inferred by using information included in the call history, the SMS history, the Email history, and the like. Moreover, no attempt has been made to apply the information on the personal relationship to various fields.

Meanwhile, according to another prior art, it is also well known that a user may input and check his or her schedule information, by using a computer program, a mobile communication device, an electronic dictionary, and the like. However, the schedule information having been inputted by the user may be simply provided to call the user's attention in a predetermined manner. Besides, no attempt has been made to reasonably infer the personal relationship between the user and the user's acquaintances by using the schedule information.

### SUMMARY OF THE INVENTION

It is, therefore, one object of the present invention to provide a method and a system for automatically attaching identification information on a certain person included in a digital data created by a digital device as one or more tags for the digital data, wherein the identification information is obtained by analyzing readable data transmitted to or received from a user of the digital device.

It is another object of the present invention to provide a method for acquiring additional information on the user by analyzing the readable data (i.e., by inferring a personal relationship of the user).

However, the objects of the present invention are not limited to the foregoing.

### BRIEF DESCRIPTION OF THE DRAWINGS

The above and other objects and features of the present invention will become apparent from the following description of preferred embodiments given in conjunction with the accompanying drawings, in which:

FIG. 1 shows a conventional face recognition technology;

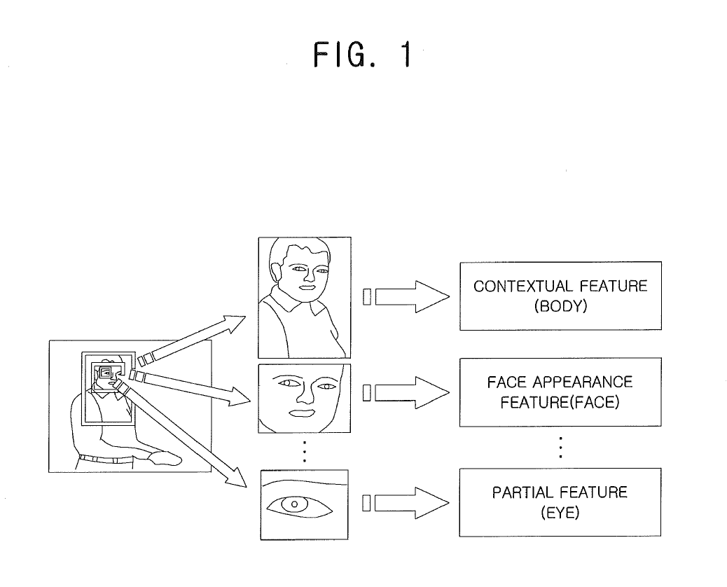

FIG. 2 provides a system for recognizing a face of a certain person included in a digital data more precisely by using readable data in accordance with the present invention;

FIG. 3 depicts an example of inferring a personal relationship of a user of a digital device from the readable data, and searching clue information for enhancing a face recognition rate by referring to the inferred personal relationship in accordance with an example embodiment of the present invention;

FIG. 4 offers another example of inferring the personal relationship of the user from the readable data, and searching the clue information by referring to the inferred personal relationship in accordance with the example embodiment of the present invention;

FIG. 5 illustrates yet another example of inferring the personal relationship from the readable data, and searching the clue information by referring to the inferred personal relationship in accordance with the example embodiment of the present invention;

FIG. 6 shows an example of inferring the personal relationship of the user from the most effective one among a plurality of readable data, and enhancing a face recognition rate by referring to the inferred personal relationship in accordance with another example embodiment of the present invention; and

FIG. 7 provides an example of inferring the personal relationship between a caller and a callee from the readable data, and enhancing a face recognition rate by referring to the inferred personal relationship in accordance with yet another embodiment of the present invention.

### DETAILED DESCRIPTION OF THE PREFERRED EMBODIMENTS

In the following detailed description, reference is made to the accompanying drawings that show, by way of illustration, specific embodiments in which the present invention may be practiced. These embodiments are described in sufficient detail to enable those skilled in the art to practice the present invention. It is to be understood that the various embodiments of the present invention, although different from one another, are not necessarily mutually exclusive. For example, a particular feature, structure, or characteristic described herein in connection with one embodiment may be implemented within other embodiments without departing from the spirit and scope of the present invention. In addition, it is to be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention will now be described in more detail, with reference to the accompanying drawings.

In accordance with one aspect of the present invention, there is provided a method for attaching tag information, by analyzing readable data, to a digital data including an image of a certain person provided by a digital device in a digital data management system, wherein the digital data management system includes identification information on a user of the digital device, and wherein the readable data includes clue information which is related to a personal relationship or a schedule of the user, the method including the steps of: (a) automatically extracting the clue information from the readable data; (b) identifying the certain person included in the digital data by using the extracted clue information; and (c) attaching one or more tags to the digital data by using information on the identified certain person.

In accordance with another aspect of the present invention, there is provided a system for attaching tag information, by analyzing readable data, to a digital data including an image of a certain person provided by a digital device, wherein the readable data includes clue information which is related to a personal relationship or a schedule of a user of the digital device, the system including: a linguistic database for storing the readable data including the clue information; a candidates list generation unit for providing information on a plurality of candidates having high probabilities of being determined as the certain person by using the readable data; and a tagging unit for attaching one or more tags to the digital data by using the information on the candidates.

In accordance with yet another aspect of the present invention, there is provided a method for inferring a personal relationship by analyzing readable data provided by a digital device, the digital device including identification information on a user of the digital device, the method including the steps of: acquiring clue information on the personal relationship from the readable data; and inferring the personal relationship between the user and a specific person by referring to the clue information.

Tagging System

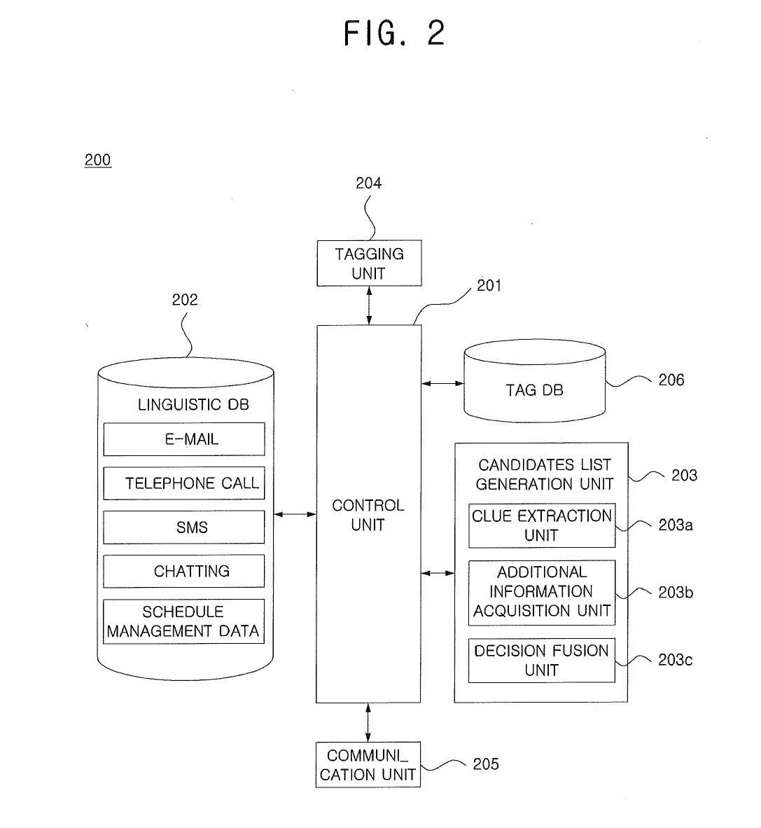

FIG. 2 provides a block diagram showing a hardware configuration of a tagging system 200 for more precisely recognizing a face of a certain person included in a digital data by using readable data in accordance with the present invention.

Herein, a definition of the terminology “readable data” will be presented along with the explanation about a linguistic database 202.

Referring to FIG. 2, the tagging system 200 may include a control unit 201, the linguistic database 202, a candidates list generation unit 203, a tagging unit 204, a communication unit 205, and a tag database 206.

The tagging system 200 attaches or recommends one or more tags to or for the digital data by extracting clue information, i.e., a personal relationship, a schedule, and the like, from the readable data, and recognizing the certain person with a high recognition rate by using the extracted clue information.

To be more specific, the control unit 201 receives the readable data from the linguistic database 202 through the communication unit 205 and controls data flow among the linguistic database 202, the candidates list generation unit 203 and the tagging unit 204 in order to extract at least one clue from the readable data and provide a candidates list including information on one or more candidates having high probabilities of being determined as the certain person through a decision fusion technique. The meaning of “decision fusion” indicates a process for making a decision on a specific issue on the basis of a plurality of clues and a priori probability.

Herein, a process for providing the candidates having the high probabilities of being determined as the certain person through the decision fusion technique is disclosed in Korean Patent Application No. 10-2006-0077416 filed on Aug. 17, 2006 (Korea Patent No. 10-2007-0701163 dated Mar. 22, 2007), which was also filed in PCT international application No. PCT/KR2006/004494 on Oct. 31, 2006, by the same applicant as that of the present invention, entitled “Methods for Tagging Person Identifier to Digital Data and Recommending Additional Tag by Using Decision Fusion”. The disclosures of International Application PCT Application No. PCT/KR2006/004494 and Korean Patent Application No. 10-2006-0077416 are incorporated herein by reference.

In the linguistic database 202, one or more readable data may be recorded, the readable data being comprised of one or more languages which can be recognized by a human being. For example, the readable data may be included in an email, a telephone call, an SMS(Short Message Service) message, a chatting (e.g., a chatting through a messenger), data generated by using a schedule management program, a telephone directory, an address book, a web log, etc. The readable data may be stored in a computer readable medium. In case of “the telephone call”, a form of a readable text, to which the contents of the telephone call is converted by a voice recognition technique, may be considered as known in the art. The computer readable medium includes a hardware device such as magnetic media (e.g., a hard disk, a floppy disk, and a magnetic tape), optical media (e.g., a CD-ROM, and a DVD), magneto-optical media (e.g., a floptical disk), a read-only memory (ROM), a random access memory (RAM), and a flash memory.

The candidates list generation unit 203 may extract one or more clues, e.g., a personal relationship, a time and a place and so forth, from the readable data, and provide the candidates list including the information on the candidates having the high probabilities of being determined as the certain person included in the digital data.

The candidates list generation unit 203 may include a clue extraction unit 203A, an additional information acquisition unit 203B and a decision fusion unit 203C.

The clue extraction unit 203A may recognize the readable data and extract the clue information, e.g., a personal relationship, a schedule (the time, the place, the event etc.), from the recognized readable data.

An exemplary method for extracting clue information from the readable data includes a natural language processing (NLP) algorithm through a Name Entity Recognition (NER) and an analysis of temporal relations. A more detailed description of the exemplary method may be presented through a web page of http://en.wikipedia.org/wiki/Named_entity_recognition which includes information on the NER, and through papers, e.g., “Analysis and Reconstruction of Temporal Relations in Multimedia Fairy Tales for Digital Cinematography” and “Contextual Disambiguation of Adverbial Scopes in Korean for Text Animation” which include information on the analysis of the temporal relations. Further, in case of a so-called standardized data, in which designated information is included at a designated location, a field lookup may be additionally used.

The clues extracted by the clue extraction unit 203A may be fused through the analysis provided by the decision fusion unit 203C, and the fused clues may be used for generating the candidates list including information on the candidates having the probabilities of being determined as the certain person.

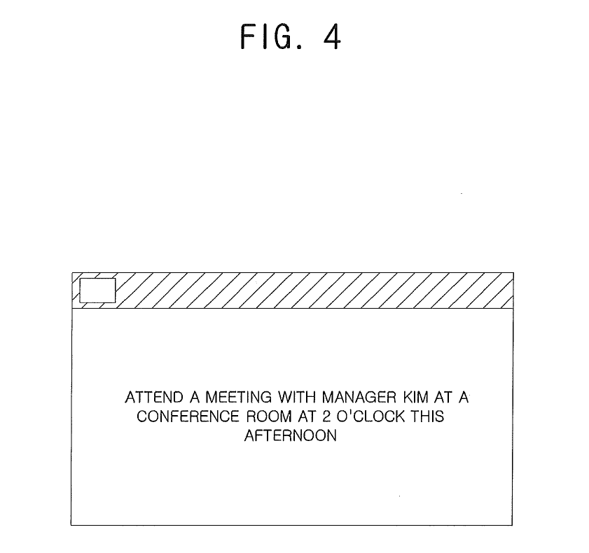

In particular, as shown in FIG. 4, if a message saying “Attend a meeting with Manager Kim at a conference room at 2 o'clock this afternoon” is received or transmitted, a certain person included in a digital data created at the place of the conference room around 2 o'clock has a high probability of being determined as the ‘Manager Kim’ and/or a receiver or a sender of the message. Accordingly, the ‘Manager Kim’ and/or the name of the receiver or the sender of the message may be recommended as a tag for the digital data.

The additional information acquisition unit 203B may acquire information (herein, referred to as additional information) other than the clues extracted from the readable data by the clue extraction unit 203A. If the additional information is acquired, the additional information may be fused with at least one of the extracted clues through the decision fusion technique, to thereby enhance the face recognition rate.

The additional information may include a time, a place and so forth at which the digital data is created. The information on the time and/or the place acquired by the additional information acquisition unit 203B and the clue information extracted by the clue extraction unit 203A are fused by the decision fusion technique so that the candidates list including the information on the candidates having the high probabilities of being determined as the certain person can be provided. For example, in case the message saying “Attend the meeting with Manager Kim at the conference room at 2 o'clock this afternoon” is provided as shown in FIG. 4, if a digital data is created around 2 o'clock, the clue information extracted by the clue extraction unit 203A has a great effect on the recognition rate. However, if the digital data is created around 7 o'clock, the clue information extracted by the clue extraction unit 203A has a small effect on the recognition rate.

Further, the additional information may include a life pattern of the user of the digital device. For instance, if the user has a habit (i.e., the life pattern) of “having a meeting from 2 o'clock to 7 o'clock on Wednesday”, the life pattern may function as the additional information. In detail, although the digital data is created at 7 o'clock on Wednesday, the certain person included in the digital data may still have a high probability of being determined as the ‘manager Kim’ and/or the receiver or the sender of the message. The additional information may also be varied according to the life pattern of the user.

As described above, the candidates list generation unit 203 may recommend, as a tag to be attached to the digital data, the candidates having high probabilities of being determined as the certain person included in the digital data, by systematically controlling the clue extraction unit 203A, the additional information acquisition unit 203B and the decision fusion unit 203C.

The candidates list generation unit 203 may provide a top N list including information on N candidates having the highest N probabilities of being determined as the certain person.

Since the explanation about the decision fusion technique performed by the decision fusion unit 203C is disclosed in Korean Patent Application No. 10-2006-0077416 as described above. The disclosures of Korean Patent Application No. 10-2006-0077416 are incorporated herein by reference.

The tagging unit 204 may attach one or more tags to the digital data, if the tags are selected among the information on the candidates recommended by the candidates list generation unit 203. Thereafter, the attached tags may be recorded in the tag database 206, which may be implemented in the form of a lookup table including the digital data and the tags attached thereto.

Extracting the Clues

In general, at least two persons may meet each other after communication has been made therebetween. Accordingly, message(s) included in the communication, i.e., contents of the readable data, may include the clue information, e.g., persons, a place, a time and a purpose related to the meeting, wherein the clue information is worth being used as the tags to be attached to the digital data.

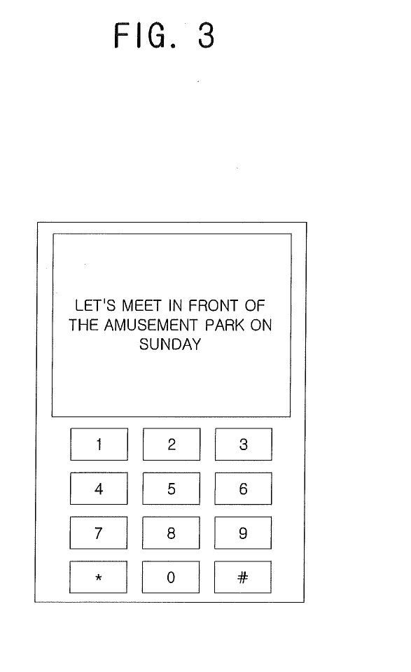

FIGS. 3 and 4 illustrate the readable data, e.g., an SMS or an email, including the clue information, e.g., a personal relationship or/and a schedule (i.e., time information, place information or purpose information).

Referring to FIG. 3, the clue extraction unit 203A may extract the clue information on the time and the place from the expressions, e.g., ‘Sunday’ and ‘in front of the amusement park’ included in the SMS message respectively. Further, since a person who has a meeting at the amusement park on Sunday may have a high probability of keeping a close relationship with the user of the digital device, the person may be inferred as a lover or a close friend of the user from the clue information.

In the mean time, referring to FIG. 4, the clue extraction unit 203A may extract the clue information on the time, the place and the personal relationship from the expressions, e.g., ‘2 o'clock this afternoon’, ‘conference room’ and ‘manager Kim’ included in the email respectively. Judging from the expressions ‘conference room’ and ‘manager Kim’, the user may be inferred to have business relationships with the receiver or the sender of the email, and the manager Kim.

If a range of a time and/or a place at which the digital data is created is included in the range(s) of the time and/or the place extracted from the aforementioned clue information, the person included in the clue information, e.g., the manager Kim in FIG. 4 or the receiver or the sender of the SMS message in FIGS. 3 and 4, may have a high probability of being determined as the certain person included in the digital data.

However, if the range of the time and/or the place at which the digital data is created is far away from the range(s) of the time and/or the place extracted from the clue information, a low probability of being determined as the certain person may be allotted to the person, e.g., the manager Kim, the receiver or the sender of the SMS message.

Herein, it should be noted that the clue information may be extracted not only from the contents provided by a Multimedia Messaging Service (MMS) and a chatting service, but also from a voice message service if a voice can be digitized by a voice recognition technique.

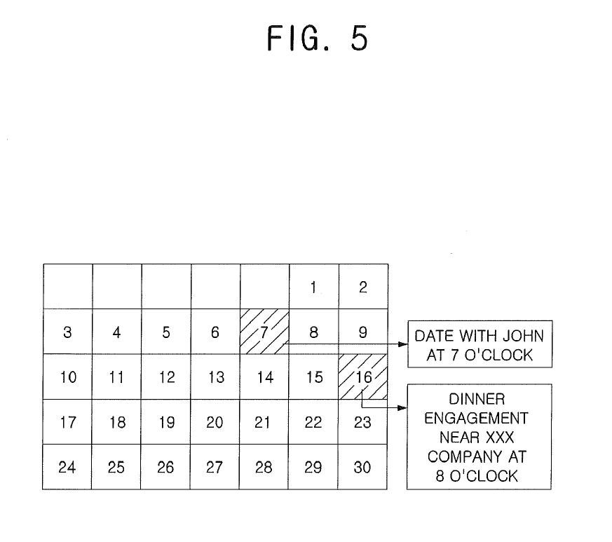

Further, the clue information may also be extracted from the readable data which is included in various types of services. As shown in FIG. 5, the clue information may be extracted from the readable data generated by a program capable of managing the schedule inputted by the user, in the same manner as the readable data generated by the communication.

FIG. 5 presents an example of a schedule inputted by the user by using the program (i.e., a schedule management program).

Referring to the schedule of FIG. 5, the user has a date with ‘John’ at 7 o'clock on the 7th and a dinner engagement near xxx Company at 8 o'clock on the 16th respectively. The clue extraction unit 203A may extract the clue information (i.e., ‘John’ at 7 o'clock on the 7th and a dinner engagement near the xxx Company at 8 o'clock on the 16th) from the contents included in the schedule management program. Accordingly, if the digital data is created around 7 o'clock on the 7th, a certain person included in the digital data has a high probability of being determined as ‘John’. Moreover, from the extracted clue information such as ‘John’ and ‘date’, the user may be inferred to have a close relationship with ‘John’ as a lover. On the other hand, if the digital data is created around 8 o'clock on the 16th, the certain person may have a high probability of being determined as a colleague, who has a business relationship with the user.

The candidates list generation unit 203 creates the candidates list including the information on the candidates having the highest N probabilities of being determined as the certain person by referring to the clue information fused by the decision fusion unit 203C. Herein, the deviations stemming from the characteristics of users of digital devices may be applied in real time to the decision fusion technique.

Herein, the clue information may also be extracted from the schedule of the user by using the natural language processing (NLP) algorithm and the field lookup as described above.

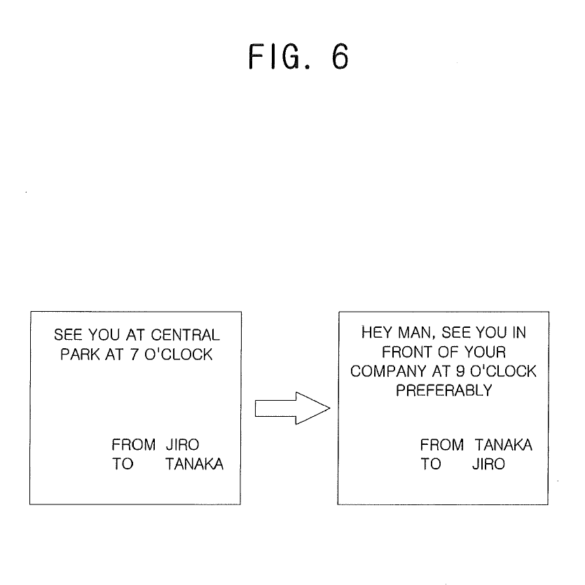

FIG. 6 represents a case in which an appointment is changed through an SMS message in accordance with another example embodiment of the present invention.

Referring to FIG. 6, Tanaka suggests a new schedule by providing a message saying “Hey man, See you in front of your company at 9 o'clock preferably”, in reply to a message of Jiro saying “See you at Central Park at 7 o'clock”. In this case, the schedule shown in the message of Jiro was effective until Tanaka sends the reply, but the new schedule suggested by Tanaka becomes the most effective after Tanaka sends the reply. In the various cases in which the schedule is generated, changed or cancelled, the clue extraction unit 203A may extract the clue information from the most effective schedule by analyzing the contents of the message.

The clue information extracted by the clue extraction unit 203A may be fused with the additional information provided by the additional information acquisition unit 203B through the analysis provided by the decision fusion unit 203C, and the fused clue information may be used for generating the candidates list including information on the candidates having the probabilities of being determined as the certain person.

Likewise, in case the user generates, changes or cancels the schedule by using the schedule management program, the candidates list generation unit 203 may also provide the candidates list including the information on the candidates having the highest N probabilities of being determined as the certain person by referring to the most effective schedule.

Moreover, judging from literary styles, e.g., “Hey man”, included in the contents of the messages of Tanaka and Jiro in FIG. 6, they may be inferred to have a friendly relationship with each other.

Additional Examples of Inferring Personal Relationship and Applications Thereof

In case the clue information on the personal relationship is included in the readable data, e.g., the SMS message, the clue information may be used for various applications by determining a degree of intimacy. For example, the information on the personal relationship may be displayed on a screen of the digital device, or the user's acquaintances may automatically divided into each category, e.g., family, friends, colleagues and the like, by referring to the information on the personal relationship, irrespective of the tag attaching process. Besides, the above-mentioned various applications may also be considered in a similar manner in case of the clue information on the schedule, even though a detailed description thereof is omitted.

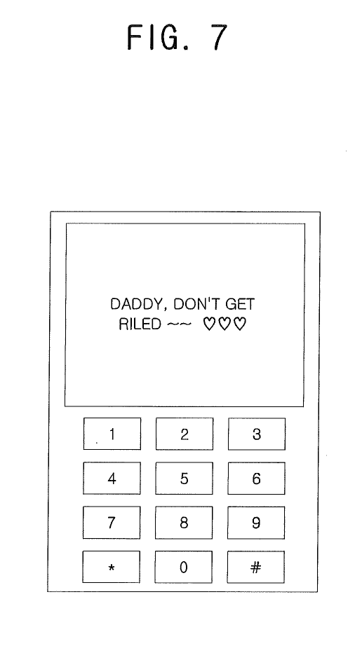

In addition, the clue information extracted from the readable data may be used for attaching tag information to the digital data. For example, the degree of intimacy may be calculated from the clue information on the personal relationship and/or the schedule. If a higher degree of intimacy is allotted to a person, the person may have a higher probability of being determined as the certain person included in the digital data. In this regard, it will be described in more detail with respect to FIG. 7.

FIG. 7 provides an example of inferring the personal relationship between a caller and a callee from the readable data, and enhancing a face recognition rate by referring to the inferred personal relationship in accordance with yet another embodiment of the present invention.

Referring to FIG. 7, there is a message including a phrase of “Daddy, don't get riled˜˜” and a shape of “♡”. By the inference from the phrase, the user of the digital device, i.e., a sender of the message, may be determined as a child of a receiver of the message, and by the inference from the shape of “♡”, the sender may be determined to have a high degree of intimacy with the receiver. Accordingly, the clue extraction unit 203A may extract the clue information representing the degree of intimacy such as the shape of “♡”, “:)”, and the like from the message, thereby inferring that the receiver has a high degree of intimacy with the sender and that the sender has a family relationship with the receiver.

The clue information on the personal relationships, i.e., the degree of intimacy with the user, may be used for allotting the probabilities to a plurality of people. Since the certain person included in the digital data created by the user may have a high degree of intimacy with the user, the degree of intimacy can be used for enhancing the face recognition rate.

However, the candidates list, which was provided based on the degree of intimacy, may be adjusted in real time through the decision fusion unit 203C. For example, even though a high degree of intimacy was allotted to a specific person, if there are few pictures taken of the specific person, the intimacy related to the specific person may be updated to a low degree of intimacy.

Other examples about the inference of the personal relationship are now described in more detail.

In case a hot key allotted to a specific person who receives or sends the readable data is registered in the digital device, the clue extraction unit 203A may infer that the specific person may have a high probability of being determined to have a high degree of intimacy with the user. In addition, if the hot key allotted to the specific person is registered in the digital device as a number close to ‘0’, the specific person may have a high probability of being determined to have a higher degree of intimacy, e.g., a family member, a lover or a close friend, of the user. However, even though the hot key allotted to the specific person is registered in the digital device as a number close to ‘0’, there is a possibility that the specific person may have a low degree of intimacy with the user. In this regard, the probability allotted to the specific person may be adjusted by referring to the life pattern and/or the readable data included in the calls, SMS messages and the like.

Meanwhile, if a name of the specific person registered in the digital device includes a special character such as the shape of “♡”, a lovely expression such as a “cutie”, a high degree of intimacy may be allotted to the specific person by the clue extraction unit 203A.

Moreover, the degree of intimacy may be determined by referring to information on a visitor to a blog or a homepage, etc of the user. For example, the degree of intimacy allotted to a specific visitor may be increased if the specific visitor writes a lot of posts or replies. Further, if the specific visitor writes more posts or more replies recently, a higher degree of intimacy may be allotted to the specific visitor. If a higher degree of intimacy is allotted to the specific visitor, the specific visitor may be determined as a family member, a close friend, a lover and the like of the user. Herein, the identity of the specific visitor may be accurately inferred by using the decision fusion technique which is capable of reflecting the characteristics of the user.

Furthermore, the degree of intimacy may be determined by referring to information on a call frequency, call duration, a time slot when a call is made and the like. For instance, as the user frequently makes a call with a specific person, the specific person may have a high degree of intimacy with the user. Moreover, if the calls are mostly made at a weekday night or on weekend, the specific person may also have a high degree of intimacy, e.g., a close friend, a family member, a lover and the like. Further, if the calls are mostly made during a daytime on a weekday, the specific person may have a high probability of being determined to have business relationship with the user. Even though the description has been presented about the calls for convenience’ sake, it may also be applicable to the email, the SMS and the like.

In the mean time, if the clue information such as a name of a specific person is extracted from official documents written out by using, e.g., Microsoft Office Excel program, Microsoft Office Word program or the like, the specific person may have a high probability of being determined to have business relationship with the user. Further, if polite expressions are included in the readable data in a message which the user sends to the specific person, the specific person may have a high probability of being determined to be older than the user.

In accordance with the present invention, there are provided a method and a system for automatically attaching one or more tags to a digital data by referring to identification information which is acquired by recognizing more precisely one or more faces included in the digital data by analyzing readable data, thereby enabling a user to manage the digital data conveniently and share them with other users efficiently.

Moreover, in accordance with the present invention, a recognition rate for the faces included in the digital data created from a digital device may be enhanced by extracting information on a personal relationship, a schedule and the like associated with a user of the digital device from the readable data.

Furthermore, in accordance with the present invention, the information on the personal relationship of the user inferred from the readable data may be utilized for various applications, e.g., categorization of the digital data, etc., without having to attach one or more tags to the digital data by recognizing one or more faces included in the digital data.

The embodiments of the present invention can be implemented in a form of executable program command through a variety of computer means recordable to computer readable media. The computer readable media may include solely or in combination, program commands, data files and data structures. The program commands recorded to the media may be components specially designed for the present invention or may be usable to a skilled person in a field of computer software. Computer readable record media include magnetic media such as hard disk, floppy disk, magnetic tape, optical media such as CD-ROM and DVD, magneto-optical media such as floptical disk and hardware devices such as ROM, RAM and flash memory specially designed to store and carry out programs. Program commands include not only a machine language code made by a complier but also a high level code that can be used by an interpreter etc., which is executed by a computer. The aforementioned hardware device can work as more than a software module to perform the action of the present invention and they can do the same in the opposite case. The various illustrative logical blocks, modules, circuits, elements, and/or components described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering this specification and the accompanying drawings. All such changes, modifications, variations and other uses and applications which do not depart from the spirit and scope of the invention are deemed to be covered by the invention which is limited only by the claims which follow.

What is claimed is:

1. A method for attaching tag information to digital data including an image of a person provided by a digital device in a digital data management system, the method comprising the steps of:
(a) automatically extracting clue information from readable data associated with digital data, the digital data including an image of a person;
(b) identifying said person by using said clue information; and
(c) attaching one or more tags to the digital data, the one or more tags being generated based on said clue information,
wherein the digital data management system includes identification information on a user of the digital device and the readable data includes the clue information which is related to a personal relationship or a schedule of the user.

2. The method of claim 1, wherein the step (b) comprises the step of:
determining a group of candidates having high probabilities of being said person by comparing the clue information with profile of the digital data, said profile including a place and a time at which the digital data has been created.

3. The method of claim 2, wherein the profile of the place is automatically acquired from a location log of the digital device, which is provided by at least one of a location tracking system and a mobile communication system, and the profile of the time is automatically acquired by referring to the time at which the digital data is created.

4. The method of claim 2, wherein, at the step (b), the group of the candidates is determined by fusing the clue information by using a decision fusion technique, the decision fusion technique indicating a process for making a decision on a specific issue on the basis of a plurality of clues and a priori probability.

5. The method of claim 1, wherein the readable data is transmitted or received by using communication means through a communication network.

6. The method of claim 5, wherein the communication means includes an email, a Short Message Service (SMS), a Multimedia Messaging Service (MMS) or a messenger program.

7. The method of claim 5, wherein the communication means includes wire and/or wireless communication means, and the readable data is recorded by digitizing a human voice recognized by the wire and/or the wireless communication means through a voice recognition technology.

8. The method of claim 1, wherein the readable data includes at least one of data generated by a program for managing a schedule inputted by the user and data included in a telephone directory, a calendar, an address book or a web log.

9. The method of claim 1, wherein the step (a) is executed by using at least one of a field lookup and a natural language processing (NLP) algorithm.

10. The method of claim 1, wherein, at the step (a), a most effective clue information is determined by referring to new clue information representing a change or a cancellation of the previous clue information.

11. The method of claim 1, wherein the information on the personal relationship includes relationships between the user and the user's acquaintances.

12. The method of claim 11, wherein the information on the personal relationship includes a degree of intimacy between the user and the user's acquaintances.

13. The method of claim 12, wherein, at the step (b), a group of candidates having high degrees of intimacy are selected among the user's acquaintances, the group of candidates having high probabilities of being the person included in the digital data.

14. The method of claim 13, wherein the readable data includes a log of data transmitted or received by a communication means through a communication network.

15. The method of claim 14, wherein a probability of allotting a high degree of intimacy to a specific acquaintance is increased, if the frequency of communication between the user and the specific acquaintance is increased.

16. The method of claim 13, wherein the readable data includes data, acquired at online websites related to the user.

17. The method of claim 13, wherein the readable data is included in a document file which is related to the user.

18. The method of claim 13, wherein the readable data includes at least one of data generated by a program for managing a schedule inputted by the user, and data included in a telephone directory, calendar, an address book or a web log.

19. A system for attaching tag information to a digital data including an image of a person provided by a digital device, the system comprising:
a linguistic database for storing readable data including clue information, the readable data being associated with digital data, the digital data including an image of a person;
a candidates list generation unit for providing information on a group of candidates having high probabilities of being said person by using the readable data; and
a tagging unit for attaching one or more tags to the digital data by using the information on the group of candidates,
wherein the clue information is related to a personal relationship or a schedule of a user of the digital device.

20. The system of claim 19, wherein the candidates list generation unit includes a clue extraction unit for extracting the clue information from the readable data.

21. The system of claim 20, wherein the candidates list generation unit further includes an additional information acquisition unit for determining the candidates by comparing the clue information with profile of the digital data, said profile including a place and a time at which the digital data has been created.

22. The system of claim 20, wherein the clue extraction unit extracts the clue information by using at least one of a field lookup and a natural language processing (NLP) algorithm.

23. The system of claim 20, wherein the clue extraction unit determines the most effective clue information by referring to clue information representing a generation, a change and a cancellation of a schedule.

24. The system of claim 19, wherein the readable data includes at least one of data generated by a communication means, data generated by a program for managing a schedule inputted by the user, and data included in a telephone directory, a calendar, an address book or a web log.

25. The system of claim 19, wherein the clue information on the personal relationship includes a degree of intimacy between the user and the user's acquaintances.

26. A method for inferring a personal relationship by analyzing readable data provided by a digital device, the method comprising the steps of:
acquiring clue information on a personal relationship from readable data associated with digital data, the readable data being provided by a digital device; and
inferring the personal relationship between a user and a person by referring to the clue information,
wherein the digital device includes identification information on the user of the digital device.

27. The method of claim 26, wherein the readable data is transmitted or received by a communication means.

28. The method of claim 26, wherein the readable data is acquired from online websites which are related to the user.

29. The method of claim 26, wherein the readable data is included in a document file which is related to the user.

30. The method of claim 26, wherein the readable data includes at least one of data generated by a program for managing a schedule inputted by the user, and data included in a telephone directory, a calendar, an address book or a web log.
